(19) United States
(12) Patent Application Publication
(10) Pub. No.: US 2014/0295898 A1
(43) Pub. Date: Oct. 2, 2014

(54) APPARATUS AND METHOD FOR TRANSMITTING MESSAGE

(71) Applicant: Samsung Electronics Co., Ltd., Gyeonggi-do (KR)

(72) Inventor: Marcinkiewicz PIOTR, Warsaw (PL)

(73) Assignee: Samsung Electronics Co., Ltd., Gyeonggi-do (KR)

(21) Appl. No.: 14/228,392

(22) Filed: Mar. 28, 2014

(30) Foreign Application Priority Data
Apr. 1, 2013 (KR) 10-2013-0035373

(51) Int. Cl. H04W 4/20

(52) U.S. Cl. CPC H04W 4/20
USPC 455/466

(57) ABSTRACT

A method of transmitting a message includes encoding each of a phone number of an initial sender of the message and phone numbers of respective one or more recipients from a transmission SMS message. A message footer is formed that includes the encoded phone number of the caller and the encoded phone numbers of the one or more recipients. The message footer is combined with a message text included in the transmission SMS message. The transmission SMS message is transmitted with the message footer to a message server.

### CLAIM OF PRIORITY

This application claims the priority under 35 U.S.C. §119(a) from Korean Application Serial No. 10-2013-0035373, which was filed in the Korean Intellectual Property Office on Apr. 1, 2013, the entire content of which is hereby incorporated by reference in its entirety.

### BACKGROUND

1. Field of the Invention

The present disclosure relates generally to an apparatus and a method for transmitting a message.

2. Description of the Related Art

A Short Messaging Service (SMS) corresponds to one type of method which permits communication over a communication network transferring small amounts of data.

When the same SMS message is transmitted to one or more recipients, the transmitted SMS message has information such as contact information only on the one recipient of the SMS message, but does not have any information on other recipients.

However, a Multimedia Messaging Service (MMS), or an e-mail, includes information on one or more recipients in a recipient list or fields such as “to”, “cc”, or “bcc”.

However, the MMS has a disadvantage in that usage costs are higher for communication when compared with SMS. Also, the e-mail has a disadvantage in that higher costs are required to use an IP protocol in comparison with both the MMS and the SMS. Further, the e-mail has another disadvantage in that communication with a server should be continuously maintained since it has no static IP address. Accordingly, the SMS has an advantage in that transmission is performed with small amounts of data and communication is performed with much lower costs in comparison with the MMS and the e-mail.

In the SMS, the recipient having received the SMS message cannot transmit another SMS message to another recipient having received the same SMS message. In other words, the recipient having received the SMS message does not have contact information about other recipients having received the same SMS message.

For example, when a first terminal transmits the same SMS message to both a second terminal and a third terminal, the second terminal cannot identify the contact information of the third terminal transmit another SMS message to the third terminal is because the second terminal did not receive information on the third terminal, such as a phone number.

Accordingly, it is required to develop a technology in which recipients having received the SMS message together within a standard protocol of the SMS message share information on the recipients.

### SUMMARY

An embodiment of the present invention provides an apparatus and a method for transmitting a message, in which a device receives an SMS message with a message footer and can transmit another SMS message to phone numbers associated with one or more other recipients of the received SMS message together.

In accordance with an aspect of the present invention, a method of transmitting a message includes encoding each of a phone number of a initial sender and respective phone numbers of one or more recipients from a transmission SMS message; forming a message footer by using the encoded phone number of the caller (initial sender of the message) and the encoded respective phone numbers of the one or more recipients; combining the message footer with a message text included in the transmission SMS message; and transmitting the transmission SMS message with the message footer to a message server.

In accordance with another aspect of the present invention, an apparatus for transmitting a message includes a controller that encodes each of a phone number of a caller (initial sender of the message) and respective phone numbers of one or more recipients from a transmission SMS message, forms a message footer by using the encoded phone number of the initial sender and the encoded phone numbers of the one or more recipients, combines the message footer with a message text included in the transmission SMS message, and transmits the transmission SMS message with the message footer to a message server; and a storage unit that stores the transmission SMS message.

In addition, a method of transmitting a message includes: encoding by a controller of a first communication device each of a phone number of an initial sender and phone numbers of respective one or more recipients from a received transmission SMS message; forming a message footer that includes the encoded phone number of the initial sender of the transmission SMS message and the encoded phone numbers of the one or more recipients; combining the formed message footer with a message text included in the transmission SMS message; and transmitting the transmission SMS message with the message footer to a message server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The present invention will be better appreciated by a person of ordinary skill in the art from the following detailed description taken in conjunction with the accompanying drawings, in which:

FIG. 1 is a block diagram schematically illustrating a non-limiting configuration of an apparatus according to an embodiment of the present invention;

FIG. 2 is a flowchart illustrating operation of a message transmitting method according to an embodiment of the present invention;

FIG. 3 is a diagram illustrating a non-limiting example of transmission of an SMS message by using a message transmitting method according to an embodiment of the present invention;

FIG. 4 is a flowchart illustrating operational s of a message transmitting method according to another embodiment of the present invention;

FIG. 5 is a flowchart illustrating operational s of a message transmitting method according to another embodiment of the present invention;

FIG. 6 is a flowchart illustrating operational s of a message transmitting method according to another embodiment of the present invention;

FIG. 7 is a diagram illustrating a non-limiting process of combining a message footer according to a message transmitting method according to another embodiment of the present invention;

FIG. 8A and FIG. 8B are diagrams illustrating that terminals of a initial sender and one or more recipients form a mesh topology according to an embodiment of the present invention;

FIG. 9A and FIG. 9B are diagrams illustrating that terminals of a initial sender and one or more recipients form a star topology;

FIG. 10 is a graph showing the numbers of messages required for performing communication in a mesh topology and a star topology;

FIG. 11 is a graph showing an estimation value of a size of a message footer according to an embodiment of the present invention; and

FIG. 12 is a diagram illustrating one non-limiting way that transmission of an SMS message can occur between apparatuses according to an embodiment of the present invention.

### DETAILED DESCRIPTION

The present invention includes various modifications to the illustrations provided herein. Specific embodiments of the present invention will be described with reference to the accompanying drawings. However, the specific embodiments do not limit the present invention, as the present invention should be construed as including all changes included in the spirit and scope of the present invention, equivalents, and replacements, as appreciated by a person of ordinary skill in the art.

While terms including ordinal numbers, such as “first” and “second,” etc., may be used to describe various components, such components are not limited by the above terms. The above terms are used only to distinguish one component from another. For example, a first component may be referred to as a second component without departing from the scope of the present invention, and likewise a second component may be referred to as a first component. The term of and/or includes a combination of a plurality of items or one of the plurality of items.

The terms used herein are merely used to aide in an understanding of the illustrative descriptions herein, and are not intended to limit the present invention to the illustrative descriptions herein. An expression used in the singular encompasses the expression of the plural, unless it has a clearly different meaning in the context. The use of “including,” “comprising,” or “having” and variations thereof herein is meant to encompass the characteristics, numbers, s, operations, elements, component parts or combinations thereof listed thereafter and equivalents thereof as well as additional items, not excluding one or more different characteristics, numbers, steps, operations, elements, component parts or combinations thereof.

Unless defined otherwise, all terms used herein including technical or scientific terms have the same meaning as are commonly understood by those skilled in the art in the context of the field of the invention. Generally used terms which are defined in the dictionary should be construed as having meanings corresponding to meanings in the context of the related art and should not be construed as ideal or excessively formal meanings unless they are clearly defined herein.

An apparatus according to an embodiment of the present invention corresponds to electronic devices such as a personal computer, a terminal apparatus, or a smart TV, and can include handheld or portable device that are functional while be handheld and/or being ported. However, although the terminal apparatus is used as an example in the following description, the present invention is not limited to the terminal.

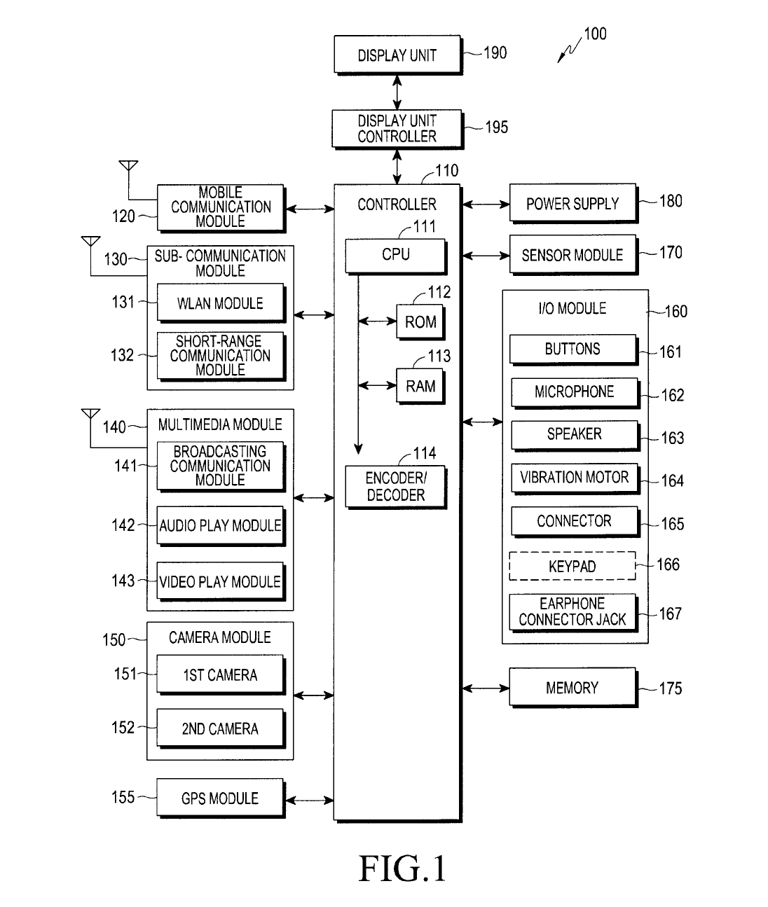

FIG. 1 is a block diagram schematically illustrating a terminal apparatus according to an embodiment of the present invention. An artisan should understand and appreciate that an apparatus according to the present invention may have fewer or additional items as those shown this drawing.

Referring now to FIG. 1, the apparatus 100 can be connected to an external device (not shown) by using an external device connector such as a sub-communication module 130, a connector 165, and an earphone connecting jack 167. The “external device” may include various devices attached to or detached from the apparatus 100 through a cable or wirelessly, such as an earphone, an external speaker, a Universal Serial Bus (USB) memory, a charger, a cradle, a docking station, a DMB antenna, a mobile payment related device, a health management device (blood sugar tester or the like), a game machine, a car navigation device and the like, just to name some non-limiting possible examples. Further, the “external device” may include short distance communication devices such as a Bluetooth communication device and a Near Field Communication (NFC) device which can be wirelessly connected to the apparatus 100 through short distance communication, a WiFi Direct communication device, and a wireless Access Point (AP). In addition, the external device may include another device, such as a mobile phone, a smart phone, a tablet PC, a desktop PC, and a server, just to name a few non-limiting devices.

Referring to FIG. 1, the apparatus 100 may include a display unit 190 and a display unit controller 195. Also, the apparatus 100 may include a controller 110, a mobile communication module 120, a sub communication module 130, a multimedia module 140, a camera module 150, a GPS module 155, an input/output module 160, a sensor module 170, a storage unit 175, and a power supplier 180. All of the modules herein include associated hardware such as circuitry for functionality and in their broadest reasonable interpretation are not software per se. The sub-communication module 130 includes at least one of a wireless LAN module 131 and/or a short distance communication module 132, and the multimedia module 140 includes at least one of a broadcasting communication module 141, an audio play (i.e. reproduction) module 142, and a video play (i.e. reproduction) module 143. The camera module 150 includes at least one of a first camera 151 and a second camera 152. The input/output module 160 includes at least one of a button 161, a microphone 162, a speaker 163, a vibration device 164, a connector 165, a keypad 166, and an earphone connecting jack 167. Hereinafter, a case of the invention in which the display unit 190 and the display unit controller 195 are practiced a touch screen and a touch screen controller, respectively will be described as an example.

The controller 110 may include a CPU 111, a ROM 112 storing a control program for controlling the apparatus 100, and a RAM 113 used as a storage area for storing a signal or data input from the outside of the apparatus 100 or for work performed in the apparatus 100. In addition, an encoder/decoder 114 can be part of an integrated functionality of the controller 110, or a separate device. The encoder/decoder 114 can encode respective phone numbers of the respective one or more recipients so as to place this reduced storage size information in the footer of the SMS transmission message. The CPU 111 includes a single core, a dual core, a triple core, or a quad core, as non-limiting examples of structure. The CPU 111, the ROM 112, and the RAM 113 can be mutually connected to each other through an internal bus.

The controller 110, which includes circuitry such as a processor or microprocessor, can control the mobile communication module 120, the sub communication module 130, the multimedia module 140, the camera module 150, the input/output module 160, the sensor module 170, the storage unit 175, the power supplier 180, the touch screen 190, and the touch screen controller 195.

The mobile communication module 120 includes hardware such as a transmitter, receiver, transceiver, modulator and demodulator to enable the apparatus 100 to be connected with the external device through mobile communication by using one antenna or a plurality of antennas according to a control of the controller 110. The mobile communication module 120 transmits/receives a wireless signal according to various protocols, for example, for voice phone communication, video phone communication, a Short Message Service (SMS), or a Multimedia Message Service (MMS) to/from a mobile phone (not shown), a smart phone (not shown), a tablet PC, or another device (not shown) having a phone number or other type of identifier such as an address input into the apparatus 100.

The sub-communication module 130 may include few items or more items than shown in FIG. 1, For example, the sub-communication module may include at least one of the wireless LAN module 131 and the short distance communication module 132. For example, the sub communication module 130 may include only the wireless LAN module 131, or only the near field communication module 132, or both the wireless LAN module 131 and the near field communication module 132. There can also be various layouts of the sub-communication module 130 or even additional sub-modules, with associated hardware.

The wireless LAN module 131 can be Internet-connected according to a control of the controller 110 in a location where a wireless Access Point (AP) (not shown) is installed, and may also access the Internet via other protocols including but not limited to such Wireless Access Protocol (WAP). The wireless LAN module 131 supports, for example, a wireless LAN standard (IEEE802.11x) of the Institute of Electrical and Electronics Engineers. The short distance communication module 132 can wirelessly perform near field communication between the portable terminal 100 and an image forming apparatus (not shown) according to a control of the controller 110. A near field communication scheme may include, for example, Bluetooth, Infrared Data Association (IrDA) communication, WiFi-Direct communication, Near Field Communication (NFC) and the like, just to name a few non-limiting examples.

The apparatus 100 may include at least one of the mobile communication module 120, the wireless LAN module 131, and the short distance communication module 132. For example, the apparatus 100 may include a combination of the mobile communication module 120, the wireless LAN module 131, and the short distance communication module 132 according to a capability thereof.

The multimedia module 140 may include, for example, the broadcasting communication module 141, the audio reproduction module 142, or the video reproduction module 143. The broadcasting communication module 141 can receive a broadcasting signal (for example, a TV broadcasting signal, a radio broadcasting signal, or a data broadcasting signal) and broadcasting supplement information (for example, Electric Program Guide: EPG or Electric Service Guide: ESG) output from a broadcasting station through a broadcasting communication antenna (not shown) according to a control of the controller 110. The audio reproduction module 142 can reproduce a digital audio file (for example, a file having a file extension of mp3, wma, ogg, or way) stored or received according to a control of the controller 110. The video reproduction module 143 can reproduce a digital video file (for example, a file having a file extension of mpeg, mpg, mp4, avi, mov, or mkv) stored or received according to a control of the controller 110. The video reproduction module 143 can reproduce the digital audio file.

The multimedia module 140 may include the audio reproduction module 142 or the video reproduction module 143 without the broadcasting communication module 141. Further, the audio reproduction module 142 or the video reproduction module 143 of the multimedia module 140 may be included in the controller 110. In other words, the configuration shown and described is illustrative and does not by implication or inference in any way limit the present invention.

The camera module 150 includes at least one of the first camera 151 and the second camera 152 for photographing a still image or a video according to a control of the controller 110. Further, the first camera 151 or the second camera 152 may include an auxiliary light source (for example, a flash (not shown) providing lights required for the photographing. The first camera 151 may be disposed on a front surface of the apparatus 100, and the second camera 152 may be disposed on a back surface of the apparatus 100, or along any surface of the apparatus. Alternatively, the first camera 151 and the second camera 152 are closely located to each other and can photograph a three-dimensional still image or a three dimensional video.

The GPS module 155 can receive radio waves from a plurality of GPS satellites (not shown) in Earth's orbit and calculate a position of the apparatus 100 by using Time of Arrival from the GPS satellites to the apparatus 100. An artisan should understand and appreciate that GPS is an example of one way position detection may be practiced with the present invention, but other types of positioning methods can be used.

The input/output module 160 includes at least one of the button 161 (which may be a physical button or a virtual button on a touch display), the microphone 162, the speaker 163, the vibration device 164, the connector 165, and the keypad 166.

The button 161 may be formed on a front surface, a side surface, or a back surface of a housing of the apparatus 100, and may include at least one of a power/lock button, a volume button, a menu button, a home button, a back button, and a search button.

The microphone 162 when receiving a voice or a sound can generate an electrical signal according to a control of the controller 110.

The speaker 163 is constructed to output sounds corresponding to various signals or data (for example, a wireless signal, a broadcasting signal, a digital audio file, a digital video file, taking a picture or the like) to the outside of the apparatus 100 according to a control of the controller 110. The speaker 163 can output a sound (for example, button tone corresponding to phone communication, ringing tone, and a voice of another user) corresponding to a function performed by the apparatus 100. One speaker 163 or a plurality of speakers 163 may be formed on a suitable position or positions of the housing of the apparatus 100.

The vibration device 164 can convert an electrical signal to a mechanical vibration according to a control of the controller 110 (i.e. piezoelectric or electro-restrictive). For example, when the apparatus 100 in a vibration mode receives phone communication from another device (not shown), the vibration device 14 is operated. One vibration device 164 or a plurality of vibration devices 164 may be formed within the housing of the portable terminal 100. The vibration device 164 can operate in accordance with a touch action of the user on the touch screen or successive motions of the touch on the touch screen 190.

The connector 165 includes hardware that may provide an interface for connecting the apparatus with an external device (not shown) or a power source (not shown). The apparatus 100 in operation can transmit or receive data stored in the storage unit 175 of the apparatus 100 to or from an external device (not shown) through a wired cable connected to the connector 165 according to a control of the controller 110. The external device may be a docking station, and the data may be an input signal transmitted from an external input device, for example, a mouse, a keyboard, touchpad, or the like, and can include gesture detection. The apparatus 100 can receive power from the power source through the wired cable connected to the connector 165 or charge a battery (not shown) by using the power source, just to name some non-limiting examples.

The keypad 166 can receive a key input from the user for the control of the apparatus 100. The keypad 166 may include a physical keypad (not shown) formed in the apparatus 100, or a virtual keypad (not shown) displayed on the display unit 190. The physical keypad (not shown) formed in the apparatus 100 may be excluded according to a capability or structure of the apparatus 100.

An earphone (not shown) is inserted into the earphone connecting jack 167 to be connected with apparatus 100.

The sensor module 170 includes at least one sensor for detecting/determining a state of the apparatus 100. For example, the sensor module 170 includes at least one of a proximity sensor for detecting whether the user approaches the apparatus 100 and a luminance sensor for detecting an amount of ambient light of the apparatus 100. Further, the sensor module 170 includes a gyro sensor and an acceleration sensor. The gyro sensor and the acceleration sensor can detect a motion of the apparatus 100 (for example, a rotation of the apparatus 100, an acceleration applied to the apparatus 100 or a vibration), detect a point of the compass by using the Earth's magnetic field, and detect a gravity action direction, and/or an orientation of the device relative to a user in the case of a handheld device (e.g. landscape versus portrait). Further, the sensor module 170 includes an altimeter for measuring an atmospheric pressure to detect an altitude. At least one of the sensors can detect the state, generate a signal corresponding to the detection, and transmit the generated signal to the controller 110. At least one of the sensors of the sensor module 170 may be added or omitted according to the capability of the apparatus 100.

The storage unit 175, which comprises a non-transitory machine readable medium, can store a signal or data input/output according to the operation of the communication module 120, the sub communication module 130, the multimedia module 140, the camera module 150, the GPS module 155, the input/output module 160, the sensor module 170, or the touch screen 190. The storage unit 175 can store a control program and applications for controlling the apparatus 100 or the controller 110.

The term “storage unit” is used as a term which refers to a random data storage device such as the storage unit 175, the ROM 112 and the RAM 113 within the controller 110, or a memory card (for example, an SD card or a memory stick) installed in the portable terminal 100. The storage unit 175 may include a nonvolatile memory, a volatile memory, a Hard Disk Drive (HDD), or a Solid State Drive (SSD), just to disclose some non-limiting examples of the many possible ways the storage unit can be structured, and more than one type of structure can be present.

The power supplier 180 can supply power to a storage device that can include one battery or a plurality of batteries (not shown) arranged at the housing of the apparatus 100 according to a control of the controller 110. The one battery or the plurality of batteries supply power to the apparatus 100. Further, the power supplier 180 can supply power input from an external power source to the apparatus 100 through a wired cable connected to the connector 165. In addition, the power supplier 180 can supply power wirelessly input from the external power source to the apparatus 100 through a wireless charging technology.

The display unit 190 may be provided as, for example, a touch screen that can provide user interfaces corresponding to various services (for example, phone communication, data transmission, broadcasting, and photography) to the user. The touch screen 190 can transmit an analog signal corresponding to at least one touch input into the user interface to the display unit controller 195, which is in this example a touch screen controller 195. The touch screen 190 can receive at least one touch through a user's body (for example, fingers including a thumb) or a touchable input means (for example, a stylus pen). the touch screen 190 may also operates by near-touch, meaning that a finger of a stylus brought within a detectable distance from the screen without actually making physical contact with the screen is considered a “touch”. Further, the touch screen 190 can receive successive motions of one particular type of touch from among the at least one touch. The touch screen 190 can transmit an analog signal corresponding to the successive motions of the input touch to the touch screen controller 195.

Moreover, an artisan should understand and appreciate that the touch used in the present invention is not limited to a contact between the touch screen 190 and the user's body or the touchable input, and may include a noncontact. A distance or interval within which the touchable input can be recognized in the touch screen 190 regardless of whether or not contact is physically made with the screen may be changed according to a capacity or structure of the apparatus 100.

The touch screen 190 can be implemented in, for example, a resistive type, a capacitive type, an infrared type, or an acoustic wave type.

The touch screen controller 195 converts an analog signal received from the touch screen 190 to a digital signal (for example, X and Y coordinates) and transmits the converted digital signal to the controller 110. The controller 110 can control the touch screen 190 by using the digital signal received from the touch screen controller 195. For example, the controller 110 can select or execute a short-cut icon (not shown) displayed on the touch screen 190 in response to the touch. Further, the touch screen controller 195 may be included in the controller 110.

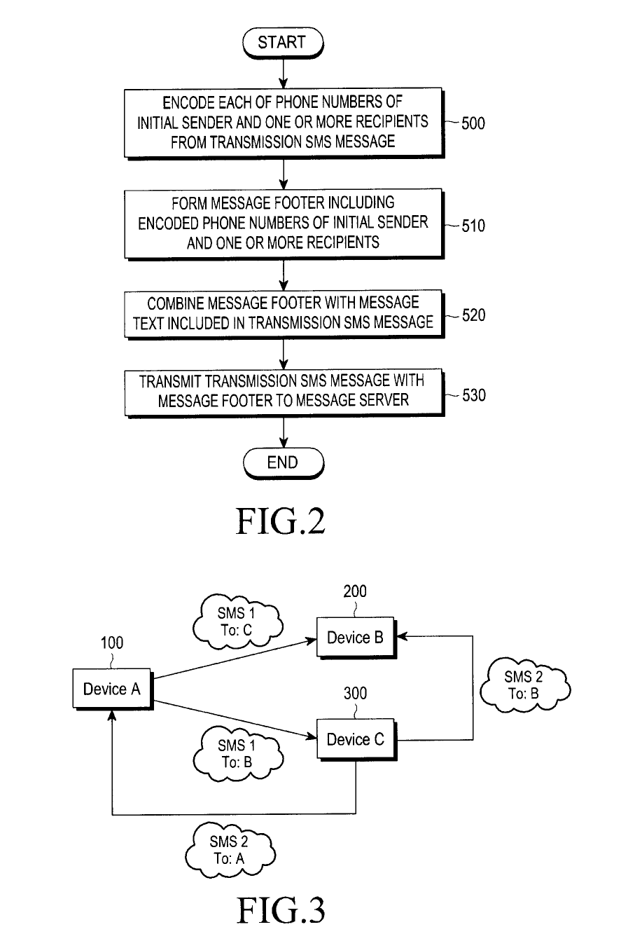

FIG. 2 is a flowchart illustrating operation of a message transmitting method according to an embodiment of the present invention.

Referring now to FIG. 2, the message transmitting method according to an embodiment of the present invention first encodes each of a phone number of a initial sender and phone numbers of one or more recipients from a received transmission SMS message at 500. For example, the controller 110 of the terminal apparatus 100 can encode each of the phone number of the initial sender and the phone numbers of the respective one or more recipients from the transmission SMS message. The transmission SMS message refers to an SMS message to be transmitted from the terminal apparatus 100. The SMS message may comply, for example, with the RFC822 standard, but the invention does not require such compliance. Further, the transmission SMS message may include a phone number of a initial sender and phone numbers of the respective one or more recipients. The controller 110 can encode each of the phone numbers of the initial sender and the phone numbers of the respective one or more recipients. When each of the phone numbers of the initial sender and the phone numbers of the respective one or more recipients is encoded, sizes of the phone numbers of the initial sender and the one or more recipients become smaller. Accordingly, although the encoded phone numbers of the initial sender and the one or more recipients are combined with a message text included in the transmission SMS message, the inclusion of these numbers in the SMS message does not create a burden for the terminal apparatus 100 to include this information in the transmission. Further, when the encoded phone numbers of the initial sender and the encoded phone numbers of the respective one or more recipients are transmitted to another terminal apparatus, the transmission is easily performed because relatively smaller amounts of data are transmitted.

At 510, a message footer is formed using the encoded phone numbers of the initial sender and the encoded phone numbers of respective one or more recipients. The controller 110, for example, may form the message footer by using the encoded phone numbers of the initial sender and the one or more recipients. In other words, the controller 110 can form the message footer by combining the encoded phone numbers of the initial sender and the one or more recipients. The message footer may be an indication that data is attached to an end of the transmission SMS message.

At 520, the message footer is combined with the message text included in the transmission SMS message. The controller 110 can combine the message footer with the message text included in the transmission SMS message. The message text may be included in the transmission SMS message. At this time, the controller 110 may combine the message footer with the message text. Further, since the message footer consists of texts, when the message text and the message footer are combined, text information may be formed.

At 530, the transmission SMS message with the message footer is transmitted to a message server. The controller 110 may transmit the transmission SMS message with the message footer to the message server. Accordingly, the message server also can receive the message footer as well as the transmission SMS message. The message footer may include the encoded phone numbers of the initial sender and the encoded phone numbers of respective one or more recipients. Accordingly, another terminal apparatus receiving the SMS message can extract the respective phone numbers of the one or more recipients by decoding the encoded phone numbers of the one or more recipients. A user of another terminal apparatus can extract not only a phone number of the terminal apparatus which transmits the SMS message but also the respective phone numbers of the one or more recipients which receive the SMS message. The user of another terminal apparatus can transmit another SMS message to the respective phone numbers of the one or more recipients in a subsequent message future. According to an embodiment of the present invention, there is an advantage of receiving the SMS message with the message footer and then transmitting another SMS message to phone numbers of one or more recipients having received the SMS message.

FIG. 3 is a diagram illustrating transmission of an SMS message using a message transmitting method according to an embodiment of the present invention. Referring now to FIG. 3, the controller 110 of a first terminal apparatus 100 (Device A) can transmit the transmission SMS message (SMS 1) with the message footer to the message server. Further, the message server can transmit the transmission SMS message (SMS 1) with the message footer to a second terminal apparatus 200 (Device B) and a third terminal apparatus 300 (Device C) corresponding to the respective one or more recipients. Accordingly, the second terminal apparatus 200 also can receive the SMS message (SMS1) with the message footer. The message may include the encoded phone numbers of the one or more recipients. Accordingly, the third terminal apparatus 300 can extract a phone number of the second terminal apparatus 200 by decoding the message footer. The third terminal apparatus 300 can then transmit another SMS message (SMS2) to the phone number of the second terminal apparatus 200. According to an embodiment of the present invention, there is an advantage in that the third terminal apparatus 300 may receive the SMS message (SMS1) with the message footer and transmit another SMS message (SMS2) to the phone number of the second terminal apparatus 200 corresponding to the one or more recipients having received the SMS message (SMS1). As illustrated in FIG. 3, the third terminal apparatus 300 can receive the SMS message (SM1) with the message footer and transmit another SMS message (SM2) to a phone number of the first terminal apparatus 100 corresponding to a caller.

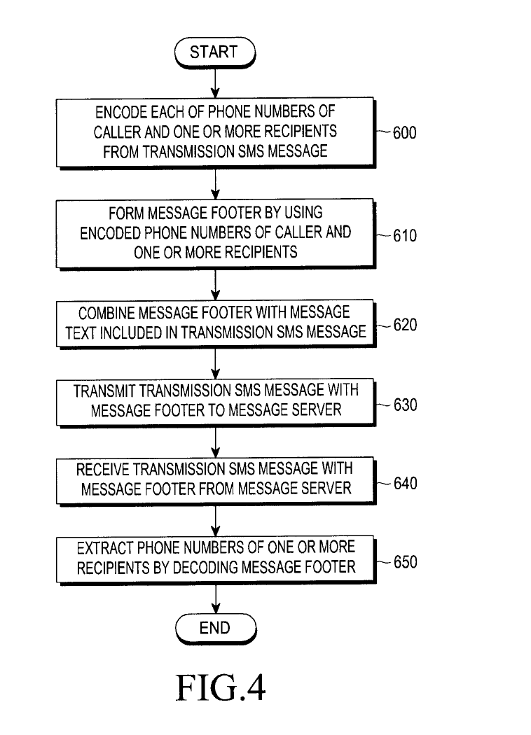

FIG. 4 is a flowchart illustrating operation of a message transmitting method according to another embodiment of the present invention.

Referring now to FIG. 4, at 600 the message transmitting method according to another embodiment of the present invention first encodes each of a phone number of a caller and phone numbers of the respective one or more recipients from a transmission SMS message. The controller 110 of the terminal apparatus 100 can encode each of the phone numbers of the caller and the respective one or more recipients from the transmission SMS message. The transmission SMS message can be defined as an SMS message to be transmitted from the terminal apparatus 100. Further, the transmission SMS message may include the phone numbers of the caller and the respective phone numbers of one or more recipients. The controller 110 can encode each of the phone numbers of the caller and the respective one or more recipients. When each of the phone numbers of the caller and the respective one or more recipients is encoded, sizes of the phone numbers of the caller and the one or more recipients become smaller. Accordingly, although the encoded phone numbers of the caller and the one or more recipients are combined with a message text included in the transmission SMS message, the inclusion of the encoded phone numbers does not create a burden for the terminal apparatus 100. Further, when the SMS message including the encoded phone numbers of the caller and the respective one or more recipients are transmitted to another terminal apparatus, the transmission is easily performed because small amounts of data are transmitted.

At 610, a message footer is formed using the encoded phone numbers of the caller and the one or more recipients. The controller 110 can form the message footer by using the encoded phone numbers of the caller and the one or more recipients. In other words, the controller 110 can form the message footer by combining the encoded phone numbers of the caller and the one or more recipients. The message footer may indicate that data is attached to an end of the transmission SMS message.

At 620, the message footer is combined with the message text included in the transmission SMS message. The controller 110 can combine the message footer with the message text included in the transmission SMS message. The message text may be included in the transmission SMS message. At this time, the controller 110 can combine the message footer with the message text. Further, since the message footer includes texts, when the message text and the message footer are combined, text information may be formed.

At 630, the transmission SMS message with the message footer is transmitted to a message server. The controller 110 can transmit the transmission SMS message with the message footer to the message server.

At 640, the controller 110 receives the transmission SMS message with the message footer from the message server. For example, the terminal apparatus can receive the transmission SMS message with the message footer from the message server. The terminal apparatus receiving the transmission SMS message with the message footer from the message server may be a terminal apparatus different from the terminal apparatus having transmitted the transmission SMS message. For example, as illustrated in FIG. 3, the terminal apparatus receiving the transmission SMS message with the message footer from the message server may be the third terminal apparatus 300 (device C), which is different from the first terminal apparatus 100 (device A) having transmitted the transmission SMS message.

Next, the controller extracts phone numbers of the one or more recipients by decoding the message footer in 650. The controller of the terminal apparatus having received the transmission SMS message from the message server can extract the phone numbers of the one or more recipients by decoding the message footer. For example, referring to FIG. 3 again, the controller of the third terminal apparatus having receiving the transmission SMS message from the message server can extract the phone numbers of the respective one or more recipients (such as device B) by decoding the message footer. In other words, as illustrated in FIG. 3, the first terminal apparatus 100 (device A) can transmit the transmission SMS message (SMS1) with the message footer to the message server. Further, the message server can transmit the transmission SMS message (SMS1) with the message footer to the second terminal apparatus 200 (device B) and the third terminal apparatus 300 (device C) which are the one or more recipients. Accordingly, the second terminal apparatus 200 also can receive the transmission SMS message (SMS1) with the message footer. The message footer may include the encoded phone numbers of the one or more recipients. Accordingly, the third terminal apparatus 300 can extract a phone number of the second terminal apparatus 200 by decoding the message footer. Therefore, the third terminal apparatus 300 can transmit another SMS message (SMS2) to the phone number of the second terminal apparatus 200.

According to an embodiment of the present invention, an artisan should appreciate that advantageously the third terminal apparatus 300 receives the SMS message (SMS1) with the message footer and transmits another SMS message (SMS2) to the phone number of the second terminal apparatus 200 corresponding to the one or more recipients having received the SMS message (SMS1). At this time, as illustrated in FIG. 3, the third terminal apparatus 300 can receive the SMS message (SMS1) with the message footer and transmit another SMS message (SMS2) to a phone number of the first terminal apparatus 100.

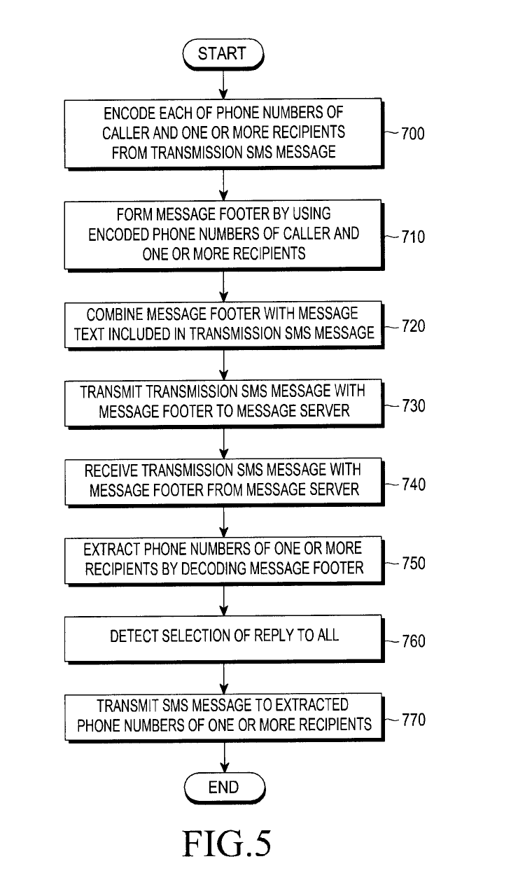

FIG. 5 is a flowchart illustrating operation of a message transmitting method according to another embodiment of the present invention.

Referring now to FIG. 5, at 700 the message transmitting method according to another embodiment of the present invention first encodes each of a phone number of a initial sender and the phone numbers of one or more recipients from the transmission SMS message. The controller 110 of the terminal apparatus 100 can encode each of the phone numbers of the initial sender and the one or more recipients from the transmission SMS message. The transmission SMS message refers to an SMS message to be transmitted from the terminal apparatus 100. Furthermore, the transmission SMS message may include the phone numbers of the initial sender and the one or more recipients. The controller 110 can encode each of the phone numbers of the initial sender and the one or more recipients. When each of the phone numbers of the initial sender and the one or more recipients is encoded, sizes of the phone numbers of the initial sender and the one or more recipients become smaller in size. Accordingly, although the encoded phone numbers of the initial sender and the one or more recipients are combined with a message text included in the transmission SMS message, the additional data does not create a burden for the terminal apparatus 100, particularly due to the reduced size of the phone numbers by the encoding. Further, when the encoded phone numbers of the initial sender and the respective one or more recipients are transmitted to another terminal apparatus, the transmission is easily performed because relatively small amounts of data are being transmitted, for example due to the payload size of SMS messages.

At 710, a message footer is formed using the encoded phone numbers of the initial sender and the respective one or more recipients. The controller 110 can form the message footer by using the encoded phone numbers of the initial sender and the one or more recipients that have been encoded by an encoder/decoder 114. In other words, the controller 110 can form the message footer by combining the encoded phone numbers of the initial sender and the one or more recipients. The message footer may refer to data attached to an end of the transmission SMS message.

At 720, the message footer is combined with the message text included in the transmission SMS message. The controller 110 can combine the message footer with the message text included in the transmission SMS message. The message text may be included in the transmission SMS message. At this time, the controller 110 can combine the message footer with the message text. Further, since the message footer is comprised in this example mainly f texts, when the message text and the message footer are combined, text information may be formed.

At 730, the transmission SMS message with the message footer is transmitted to a message server. The controller 110 can transmit the transmission SMS message with the message footer to the message server.

At 740, the controller 110 receives the transmission SMS message with the message footer from the message server. The terminal apparatus can receive the transmission SMS message with the message footer from the message server. The terminal apparatus receiving the transmission SMS message with the message footer from the message server may be a terminal apparatus different from the terminal apparatus having transmitted the transmission SMS message. For example, as illustrated in FIG. 3, the terminal apparatus receiving the transmission SMS message with the message footer from the message server may be the third terminal apparatus 300 (Device C) different from the first terminal apparatus 100 (Device A) having transmitted the transmission SMS message.

At 750, the controller 110 extracts phone numbers of the one or more recipients by decoding the message footer via encoder/decoder 114. The controller of the terminal apparatus having received the transmission SMS message from the message server can extract the phone numbers of the one or more recipients by decoding the message footer. For example, the controller of the third terminal apparatus having receiving the transmission SMS message from the message server can extract phone numbers of the second terminal apparatus, a fourth terminal apparatus, and a fifth terminal apparatus corresponding to the one or more recipients by decoding the message footer. Further, the controller of the third terminal apparatus can extract a phone number of the first terminal apparatus corresponding to the initial sender by decoding the message footer.

At 760, a selection of “reply to all” is detected. The controller of the terminal apparatus having received the transmission SMS message can detect the selection of the reply to all. The “reply to all” refers to transmission of the SMS message to all of the extracted phone numbers of the one or more recipients.

For example, the controller of the third terminal apparatus having received the transmission SMS message can display an icon of the “reply to all” on a display unit. Further, when the icon is selected, the controller of the third terminal apparatus recognizes that the reply to all is selected. For example, the display unit is implemented by a touch screen to display the icon of the reply to all on the touch screen. Further, when a touch for selecting the icon of the reply to all is detected, the controller of the third terminal apparatus recognizes that the reply to all is selected.

At 770, when the selection is detected, the SMS message is transmitted to the extracted phone numbers of the one or more recipients. When the selection of the reply to all is detected, the controller of the terminal apparatus having received the transmission SMS message can transmit the SMS message to all of the extracted phone numbers of the one or more recipients. For example, the controller of the third terminal apparatus having received the transmission SMS message can transmit the SMS message to all of the extracted phone numbers of the respective one or more recipients (phone numbers of the second terminal apparatus, the fourth terminal apparatus, and the fifth terminal apparatus).

According to an embodiment of the present invention, there is an advantage in that the third terminal apparatus receives the SMS message (SMS1) with the message footer and transmits another SMS message (SMS2) to all of the phone numbers of the second terminal apparatus, the fourth terminal apparatus, and the fifth terminal apparatus corresponding to the one or more recipients having receiving the SMS message (SMS1). At this time, the third terminal apparatus 300 can receive the SMS message (SMS1) with the message footer and transmit another SMS message (SMS2) to a phone number of the first terminal apparatus 100 corresponding to the caller (i.e. initial sender). According to an embodiment of the present invention, there is an advantage of transmitting the SMS message to all of one or more recipients by decoding the message footer to extract phone numbers of the one or more recipients.

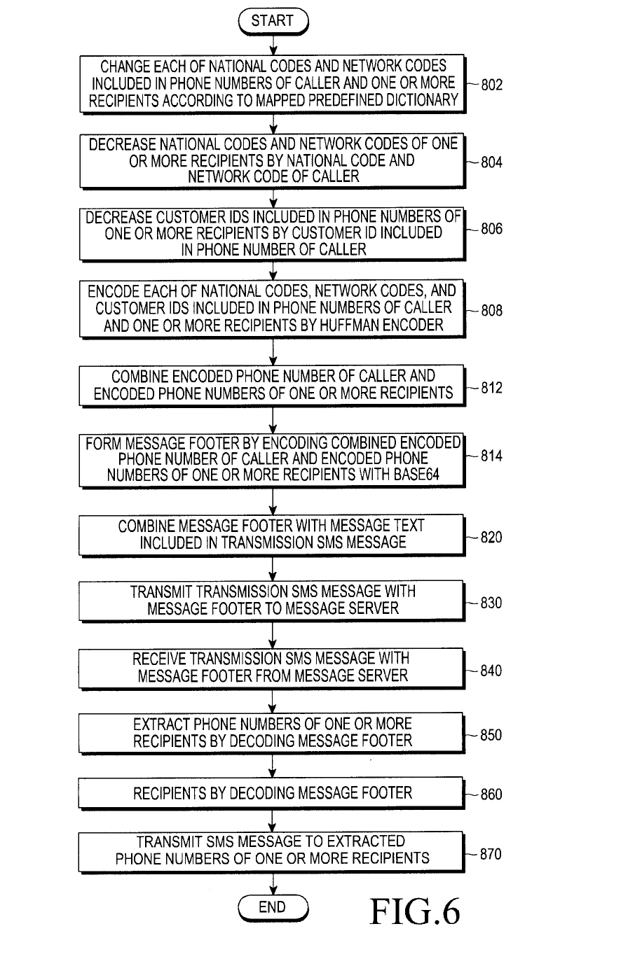

FIG. 6 is a flowchart illustrating operation of a message transmitting method according to another embodiment of the present invention.

Referring now to FIG. 6, the message transmitting method according to another embodiment of the present invention first encodes each of a phone number of a caller and phone numbers of one or more recipients from the transmission SMS message. The controller 110 of the terminal apparatus 100 can encode each of the phone numbers of the caller and the respective one or more recipients from the transmission SMS message. The transmission SMS message means an SMS message to be transmitted from the terminal apparatus 100. Further, the transmission SMS message may include the phone numbers of the caller and the respective one or more recipients. The controller 110 can encode each of the phone numbers of the caller and the one or more recipients.

At 802, each of national codes and network codes included in the phone numbers of the caller and the one or more recipients is changed according to a mapped predefined dictionary. The controller of the terminal apparatus can change each of the national codes and network codes included in the phone numbers of the caller and the one or more recipients according to the mapped predefined dictionary.

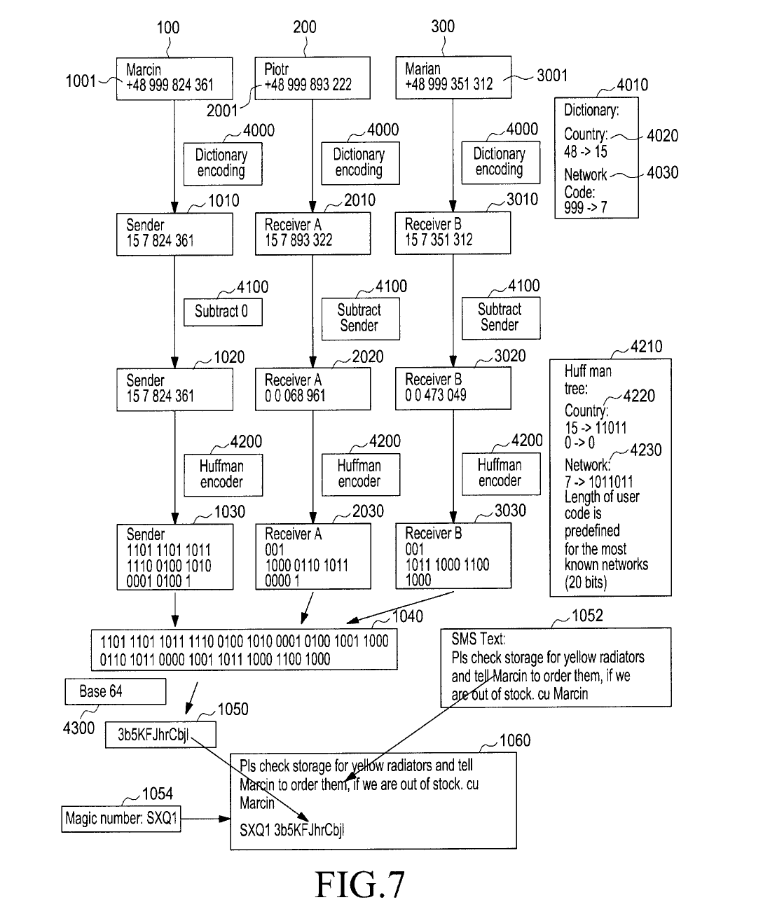

In addition, FIG. 7 is a diagram illustrating a process of combining a message footer according to a message transmitting method according to another embodiment of the present invention.

Referring now to FIG. 7, a phone number 1001 of the first terminal apparatus 100, a phone number 2001 of the second terminal apparatus 200 corresponding to the terminal apparatus of the one or more recipients, and a phone number 3001 of the third terminal apparatus 300 are shown. Each of the phone numbers 1001, 2001, and 3001 includes a national code, a network code, and a customer ID. For example, as illustrated in FIG. 7, the phone number 1001 of the first terminal apparatus 100 corresponding to the caller may include a national code corresponding to “48”, a network code corresponding to “999”, and a customer ID corresponding to “825 361”. The phone number 2001 of the second terminal apparatus 200 corresponding to the terminal apparatus of the one or more recipients may include a national code corresponding to “48”, a network code corresponding to “999”, and a customer ID corresponding to “893 322”. The phone number 3001 of the third terminal apparatus 300 corresponding to the terminal apparatus of the one or more recipients may include a national code corresponding to “48”, a network code corresponding to “999”, and a customer ID corresponding to “351 312”.

At this time, the controller of the first terminal apparatus can change the national code and the network code according to a mapped predefined dictionary 4010. More specifically, the mapped predefined dictionary 4010 may be pre-stored in the storage unit 175. Furthermore, in the mapped predefined dictionary, a mapped national code 4020 and a mapped network code 4030 corresponding to the national code and the network code may be established in a table form. Accordingly, the controller 110 extracts the mapped national code and the mapped network code corresponding to the national code and the network code from the mapped predefined dictionary established in the table form. Further, the controller 110 can change the national code and the network code into the mapped national code and mapped network code extracted from the mapped predefined dictionary.

For example, as illustrated in FIG. 7, the controller 110 can change the national code “48” included in the phone number 1001 of the first terminal apparatus 100 corresponding to the caller into a national code “15” 1010 according to the mapped predefined dictionary 4020 and change the network code “999” of the caller into a network code “7” 1010 according to the mapped predefined dictionary 4030. Accordingly, the phone number 1001 of the first terminal apparatus 100 corresponding the caller may be changed into “15 7 824 361”.

The controller 110 can change the national code “48” included in the phone number 2001 of the second terminal apparatus 200 corresponding to the one or more recipients into a national code “15” 2010 according to the mapped predefined dictionary 4020 and change the network code “999” of the one or more recipients into a network code “7” 2010 according to the mapped predefined dictionary 4030. Accordingly, the phone number 2001 of the second terminal apparatus 200 corresponding to the one or more recipients may be changed into “15 7 893 322”.

The controller 110, for example, is configured to change the national code “48” included in the phone number 3001 of the third terminal apparatus 300 corresponding to the one or more recipients into a national code “15” 3010 according to the mapped predefined dictionary 4020 and change the network code “999” of the one or more recipients into a network code “7” 3010 according to the mapped predefined dictionary 4030. Accordingly, the phone number 3001 of the third terminal apparatus 300 corresponding to the one or more recipients may be changed into “15 7 351 312”.

Referring back to FIG. 6, at 804, the national codes and the network codes of the one or more recipients are decreased by the national code and the network code of the caller. The controller of the terminal apparatus can decrease the national codes and the network codes of the one or more recipients by the national code and the network code of the caller. For example, as illustrated in FIG. 7, the controller of the first terminal apparatus corresponding to the caller can decrease the national code and the network code of the second terminal apparatus corresponding to the one or more recipients by the national code and the network code of the first apparatus. That is, the national code “15” and the network code “7” of the second terminal apparatus may be decreased by the national code “15” and the network code “7” of the first terminal apparatus, so that the national code is changed into “0” and the network code is changed into “0” 2020. The controller of the first terminal apparatus corresponding to the caller can decrease the national code and the network code of the third terminal apparatus corresponding to the one or more recipients by the national code and the network code of the first apparatus. That is, the national code “15” and the network code “7” of the third terminal apparatus may be decreased by the national code “15” and the network code “7” of the first terminal apparatus, so that the national code is changed into “0” and the network code is changed into “0” 3020. Accordingly, when the caller and the recipient are located in adjacent nations or the same nation, the national code or the network code may be decreased even more.

At 806, customer IDs included in the phone numbers of the one or more recipients are decreased by a customer ID included in the phone number of the caller. The controller of the terminal apparatus can decrease the customer IDs of the one or more recipients by the customer ID of the caller. For example, as illustrated in FIG. 7, the controller of the first terminal apparatus corresponding to the caller can decrease a customer ID of the second terminal apparatus corresponding to the one or more recipients by the customer ID of the first terminal apparatus. In other words, the customer ID “893 322” of the second terminal apparatus may be decreased by the customer ID “824 361” of the first terminal apparatus and thus changed into “368 961” 2020. The controller of the first terminal apparatus corresponding to the caller can decrease a customer ID of the third terminal apparatus corresponding to the one or more recipients by the customer ID of the first terminal apparatus. For example, the customer ID “351 312” of the third terminal apparatus may be decreased by the customer ID “824 361” of the first terminal apparatus and thus changed into “−473 049” 3020.

At 808, each of the national codes, the network codes, and the customer IDs included in the phone numbers of the caller and the one or more recipients is encoded by a Huffman encoder. The controller of the terminal apparatus can encode each of the national codes, the network codes, and the customer IDs included in the phone numbers of the caller and the one or more recipients is encoded by the Huffman encoder. The Huffman encoder can perform an encoding operation with a predefined Huffman tree through a Huffman algorithm. For example, as illustrated in FIG. 7, the controller of the first terminal apparatus corresponding to the caller (e.g. initial sender) can encode each of the national code, the network code, and the customer ID included in the phone number of the caller by the Huffman encoder. Therefore, the controller of the first terminal apparatus can encode the national code, the network code, and the customer ID included in the phone number of the caller corresponding to “15 7 824 361” 1020 into “1101 1101 1011 1110 0100 1010 0001 0110 1” 1030 by the Huffman encoder. The controller of the first terminal apparatus can encode the national code, the network code, and the customer ID included in the phone number of the second terminal apparatus corresponding to the one or more recipients, which are “0 0 068 961” 2020 into “001 1000 0110 1011 0000 1” by the Huffman encoder. The controller of the first terminal apparatus can encode the national code, the network code, and the customer ID included in the phone number of the third terminal apparatus corresponding to the one or more recipients, which are “0 0−473 049” 3020 into “0001 1011 1000 1100 1000” by the Huffman encoder. When the encoding is performed, communication is performed through a movement of small amounts of data.

At 814, a message footer is formed using the encoded phone numbers of the caller and the respective one or more recipients. The controller 110 of the terminal apparatus can form the message footer by using the encoded phone numbers of the caller and the one or more recipients. For example, the controller 110 can form the message footer by combining the encoded phone numbers of the caller and the one or more recipients. The message footer may mean data attached to an end of the transmission SMS message.

At 812, the encoded phone number of the caller and the encoded phone numbers of the respective one or more recipients are combined. The controller 110 of the terminal apparatus can combine the encoded phone number of the caller and the encoded phone numbers of the one or more recipients. For example, as illustrated in FIG. 7, the controller 110 can combine “1101 1101 1011 1110 0100 1010 0001 0110 1” 1030 corresponding to the encoded phone number of the caller, “001 1000 0110 1011 0000 1” 2030 corresponding to the encoded phone number of the second terminal apparatus which is one of the phone numbers of the one or more recipients, and “0001 1011 1000 1100 1000” 3030 corresponding to the encoded phone number of the third terminal apparatus which is one of the phone numbers of the one or more recipients. Accordingly, the controller 110 can combine the encoded phone number of the caller and the encoded phone numbers of the one or more recipients into “1101 1101 1011 1110 0100 1010 0001 0110 1001 1000 0110 1011 0000 1001 1011 1000 1100 1000” 1040.

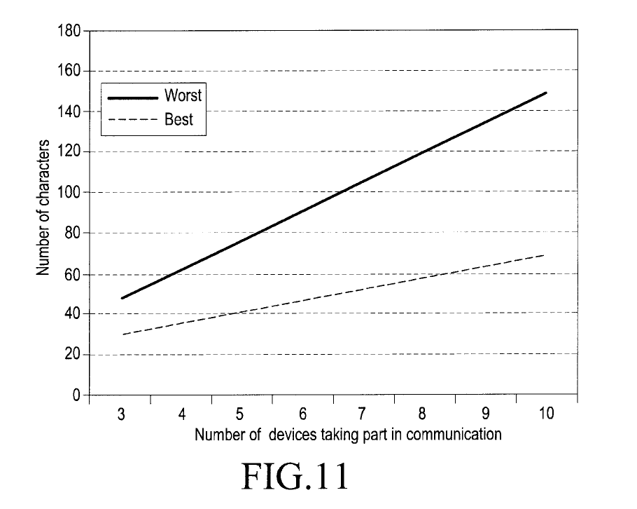

Next, the encoded phone number of the caller and the encode phone numbers of the one or more recipients are encoded with BASE64 in 814. The controller 110 of the terminal apparatus can encode the combined encoded phone number of the caller and encode phone numbers of the one or more recipients with BASE64. For example, as illustrated in FIG. 7, the controller 110 can encode “1101 1101 1011 1110 0100 1010 0001 0110 1001 1000 0110 1011 0000 1001 1011 1000 1100 1000” 1040 corresponding to the combined encoded phone number of the caller and encode phone numbers of the one or more recipients into “3b5KFJhrCbil” 1050 by the BASE64 4300. Accordingly, the controller 110 forms a message footer 1050 by the combined encoded phone number of the caller and encode phone numbers of the one or more recipients encoded with the BASE64. At this time, a magic number may be combined with the message footer 1050. For example, as illustrated in FIG. 7, the magic number may consist of “SXQ1” and be combined with the message footer 1050. A size of the message footer according to an embodiment of the present invention may be estimated as illustrated in FIG. 11. FIG. 11 is a graph illustrating an estimation value of the size of the message footer according to an embodiment of the present invention. Referring now to FIG. 11, in a best case, when the number of one or more recipients corresponding to a horizontal axis ranges from 3 to 10, the size of the message footer corresponding to a vertical axis may range from 30 to 68 characters. In a worse case, when the number of one or more recipients corresponding to a horizontal axis ranges from 3 to 10, the size of the message footer corresponding to a vertical axis may range from 48 to 149 characters.

At 820, the message footer is combined with the message text included in the transmission SMS message. The controller 110 can combine the message footer with the message text included in the transmission SMS message. The message text may be included in the transmission SMS message. At this time, the controller 110 can combine the message footer with the message text. Further, since the message footer consists of the text, when the message text and the message footer are combined, text information is formed. For example, as illustrated in FIG. 7, the controller 110 can combine the message footer 1050 corresponding to “3b5KFJhrCbil” 1050 with the message text corresponding to “Pls check storage for yellow radiators and tell Marcin to order them, if we are out of stock. cu Marcin” 1052.

At 830, the transmission SMS message with the message footer is transmitted to the message server. The controller 110 can transmit the transmission SMS message with the message footer to the message server. For example, as illustrated in FIG. 7, the controller 110 can transmit the transmission SMS message 1060 in which the message footer 1050 corresponding to “3b5KFJhrCbil” 1050 is combined with the message text corresponding to “Pls check storage for yellow radiators and tell Marcin to order them, if we are out of stock. cu Marcin” 1052 to the message server.

At 840, the transmission SMS message with the message footer is received from the message server. The terminal apparatus can receive the transmission SMS message with the message footer from the message server. At this time, the terminal apparatus receiving the transmission SMS message with the message footer from the message server may be a terminal apparatus different from the terminal apparatus having transmitted the transmission SMS message. For example, as illustrated in FIG. 3, the terminal apparatus receiving the transmission SMS message with the message footer from the message server may be the third terminal apparatus 300 (Device C) different from the first terminal apparatus 100 (Device A) having transmitted the transmission SMS message.

At 850, the controller extracts phone numbers of the one or more recipients by decoding the message footer. The controller of the terminal apparatus having received the transmission SMS message from the message server can extract the phone numbers of the one or more recipients by decoding the message footer. For example, the controller of the third terminal apparatus having receiving the transmission SMS message from the message server can extract phone numbers of the second terminal apparatus, a fourth terminal apparatus, and a fifth terminal apparatus corresponding to the one or more recipients by decoding the message footer. Further, the controller of the third terminal apparatus can extract a phone number of the first terminal apparatus corresponding to the caller by decoding the message footer. For example, as illustrated in FIG. 7, the controller of the third terminal apparatus can extract “48 999 893 322” which is the phone number of the second terminal apparatus and “48 999 824 361” which is the phone number of the first terminal apparatus corresponding to the caller by decoding the message footer corresponding to “3b5KFJhrCbil” 1050.

At 860, a selection of reply to all is detected. The controller of the terminal apparatus having received the transmission SMS message can detect the selection of the reply to all. The reply to all refers to the transmission of the SMS message to all of the extracted phone numbers of the one or more recipients. For example, the controller of the third terminal apparatus having received the transmission SMS message can display an icon of the reply to all on a display unit. Further, when the icon is selected, the controller of the third terminal apparatus recognizes that the reply to all is selected. For example, the display unit is implemented by a touch screen to display the icon of the reply to all on the touch screen. Further, when a touch for selecting the icon of the reply to all is detected, the controller of the third terminal apparatus recognizes that the reply to all is selected.

At 870, when the selection is detected, the SMS message is transmitted to the extracted phone numbers of the one or more recipients. When the selection of the reply to all is detected, the controller of the terminal apparatus having received the transmission SMS message can transmit the SMS message to all of the extracted phone numbers of the respective one or more recipients. For example, the controller of the third terminal apparatus having received the transmission SMS message can transmit the SMS message to all of the extracted phone numbers of the one or more recipients (phone numbers of the second terminal apparatus, the forth terminal apparatus, and the fifth terminal apparatus). Further, the controller of the third terminal apparatus can transmit the SMS message to the extracted phone number of the caller. For example, as illustrated in FIG. 7, the controller of the third terminal apparatus 300 having received the transmission SMS message can transmit the SMS message to “48 999 893 322” corresponding to the extracted phone number (phone number of the second terminal apparatus) of the respective one or more recipients. Further, the controller of the third terminal apparatus 300 can transmit the SMS message to “48 999 824 361” corresponding to the extracted phone number of the caller.

According to an embodiment of the present invention, there is an advantage in that the third terminal apparatus receives the SMS message (SMS1) with the message footer and transmits another SMS message (SMS2) to the phone number of the second terminal apparatus corresponding to the one or more recipients having receiving the SMS message (SMS1). At this time, the third terminal apparatus 300 can receive the SMS message (SMS1) with the message footer 1060 and transmit another SMS message (SMS2) to a phone number of the first terminal apparatus 100 corresponding to the caller. According to an embodiment of the present invention, there is an advantage of transmitting the SMS message to all of one or more recipients by decoding the message footer to extract phone numbers of the one or more recipients.

Further, according to an embodiment of the present invention, the terminal apparatuses of the caller (i.e. initial sender) and the one or more recipients can form a mesh topology or a star topology.

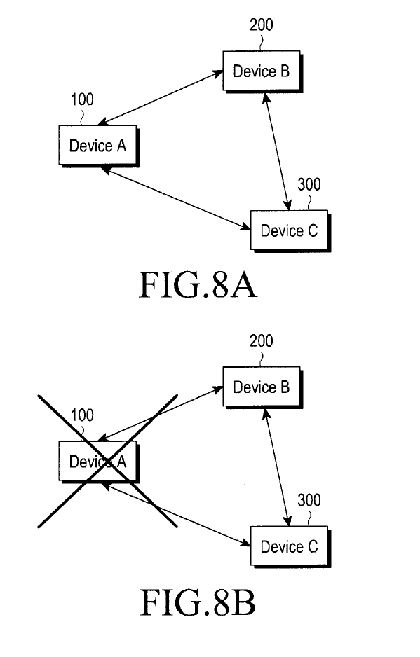

FIGS. 8A and 8B are diagrams illustrating that the caller and terminal apparatuses of the one or more recipients form a mesh topology according to an embodiment of the present invention.

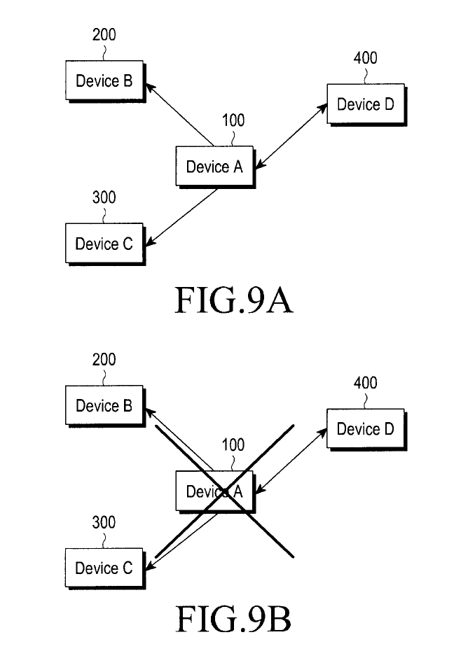

FIGS. 9A and 9B are diagrams illustrating that the caller and terminal apparatuses of the one or more recipients form a star topology.

Referring now to FIGS. 8A and 8B, when the caller 100 and the terminal apparatuses 200 and 300 of the one or more recipients form the mesh topology according to an embodiment of the present invention, the terminal apparatuses 200 and 300 can perform communication with each other after the terminal apparatus 100 of the caller having first transmitted the SMS message is removed as illustrated in FIG. 8B.

However, referring now to FIGS. 9A and 9B, in the star topology, the terminal apparatuses 200, 300, and 400 cannot perform communication after the terminal apparatus 100 of the caller having first transmitted the SMS message is removed as illustrated in FIG. 9B.

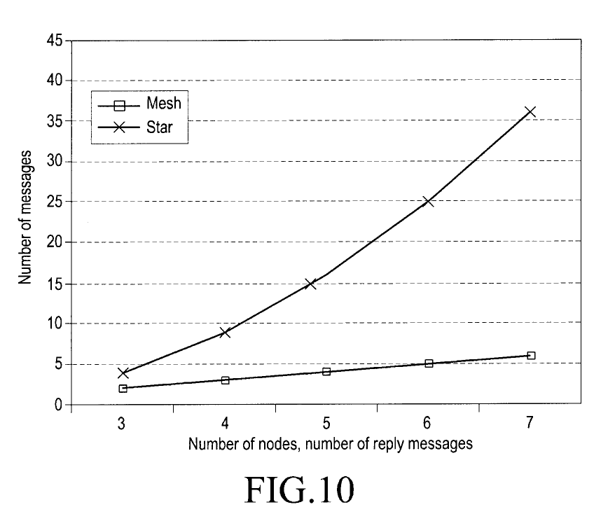

FIG. 10 is a graph showing the number of messages required for performing communication in the mesh topology and the star topology. Referring now to FIG. 10, with respect to “n” messages corresponding to the horizontal axis, all communication can be performed when only n messages are transmitted between the terminal apparatuses based on the mesh topology according to an embodiment of the present invention. However, with respect to n messages corresponding to the horizontal axis, all communication can be performed when (n−1)2 messages are transmitted between the terminal apparatuses based on the star topology.

According to an embodiment of the present invention, even when a terminal apparatus which does not provide a function related to the message footer exists among the terminal apparatuses, the SMS message can be transmitted to all the terminal apparatuses.

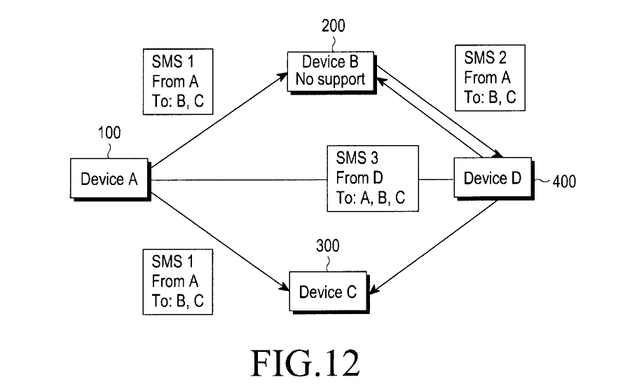

FIG. 12 is a diagram illustrating transmission of the SMS message between the terminal apparatuses according to an embodiment of the present invention. Referring now to FIG. 12, the first terminal apparatus 100 corresponding to the caller transmits the SMS message to both the second terminal apparatus 200 which does not provide a function related to the message footer and the third terminal apparatus 300 which provides the message footer function. At this time, since the fourth terminal apparatus 400 receiving the SMS message from the second terminal apparatus 200 provides the message footer function, the fourth terminal apparatus 400 can transmit the SMS message to all of the first terminal apparatus 100, the second terminal apparatus 200, and the third terminal apparatus 300 by decoding the message footer. According to an embodiment of the present invention, even when a terminal apparatus which does not provide a function related to the message footer exists among the terminal apparatuses, the SMS message can be transmitted to all the terminal apparatuses.

According to an embodiment of the present invention, there is an advantage of receiving an SMS message with a message footer and then transmitting another SMS message to phone numbers of one or more recipients having received the SMS message.

According to an embodiment of the present invention, there is an advantage of receiving an SMS message with a message footer and then transmitting another SMS message to all phone numbers of terminal apparatus corresponding to one or more recipients having received the SMS message.

According to an embodiment of the present invention, there is an advantage of decoding a message footer to extract phone numbers of one or more recipients and then transmitting an SMS message to all the one or more recipients.

The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller, or the programmable hardware contain circuitry that may be integrated, and can include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “controller”, “processor” or “microprocessor” constitute hardware in the claimed invention. Under the broadest reasonable interpretation, the appended claims constitute statutory subject matter in compliance with 35 U.S.C. §101 and none of the elements constitute of software per se.

The terms “unit” or “module” as may be used herein is to be understood as constituting or operating in conjunction with hardware such as a circuit, integrated circuit, processor or microprocessor configured for a certain desired functionality in accordance with statutory subject matter under 35 U.S.C. §101, and such terms do not constitute software per se.

A person of ordinary skill in the art may appreciate that the embodiments of the present invention can be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. An artisan can also appreciate that the memory included in the mobile terminal is one example of machine-readable devices suitable for storing a program including instructions that are executed by a processor device to thereby implement embodiments of the present invention. Therefore, embodiments of the present invention provide a program including codes for implementing a system or method claimed in any claim of the accompanying claims and a machine-readable device for storing such a program. Further, this program may be electronically conveyed through any medium such as a communication signal transferred via a wired or wireless connection, and embodiments of the present invention appropriately include equivalents thereto.

Further, the mobile device can receive the program from a program providing apparatus connected to the mobile device wirelessly or through a wire and store the received program. The program providing apparatus may include a memory for storing a program containing instructions for allowing the mobile device to perform a preset content protecting method and information required for the content protecting method, a communication unit for performing wired or wireless communication with the mobile device, and a controller for transmitting the corresponding program to the mobile device according to a request of the mobile device or automatically.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A method of transmitting a message, the method comprising:
encoding by a controller of a first communication device each of a phone number of an initial sender and phone numbers of respective one or more recipients from a received transmission SMS message;
forming a message footer that includes the encoded phone number of the initial sender of the transmission SMS message and the encoded phone numbers of the one or more recipients;
combining the formed message footer with a message text included in the transmission SMS message; and
transmitting the transmission SMS message with the message footer to a message server.

2. The method of claim 1, further comprising:
receiving from the message server the transmission SMS message transmitted by the first communication device with the message footer; and
extracting the phone numbers of the respective one or more recipients by decoding the message footer of the received transmission SMS message.

3. The method of claim 2, further comprising:
detecting by the controller of the first communication device a selection of reply to all; and
transmitting an SMS message to the extracted phone numbers of the respective one or more recipients when the selection is detected.

4. The method of claim 3, wherein the extracted phone number of the initial sender is transmitted the SMS message.

5. The method of claim 1, wherein encoding said each of the phone number of the initial sender and the phone numbers of the respective one or more recipients from the transmission SMS message comprises changing each of national codes and network codes included in the phone number of the initial sender and the phone numbers of the respective one or more recipients according to a mapped predefined dictionary.

6. The method of claim 5, wherein encoding said each of the phone number of the initial sender and the phone numbers of the respective one or more recipients from the transmission SMS message comprises:
decreasing a length of the national codes and the network codes of the respective one or more recipients by the national code and the network code of the initial sender; and
decreasing a length of customer IDs included in the phone numbers of the respective one or more recipients by a customer ID included in the phone number of the initial sender.

7. The method of claim 6, wherein encoding said each of the phone number of the initial sender and the phone numbers of the respective one or more recipients from the transmission SMS message comprises encoding the national codes, the network codes, and the customer IDs included in the phone number of the initial sender and the phone numbers of the respective one or more recipients by a Huffman encoder.

8. The method of claim 1, wherein forming the message footer by using the encoded phone number of the initial sender and the encoded phone numbers of the respective one or more recipients comprises:
combining the encoded phone number of the initial sender and the encoded phone numbers of the respective one or more recipients; and
encoding the combined encoded phone number of the initial sender and encoded phone numbers of the respective one or more recipients with BASE64.

9. The method of claim 1, wherein the message footer indicates that data is attached to the transmission SMS message.

10. The method of claim 1, wherein the respective one or more recipients comprises at least three are arranged with the initial sender in a mesh or a star topology.

11. An apparatus for transmitting a message, the apparatus comprising:
a controller that encodes each of a phone number of an initial sender and phone numbers of respective one or more recipients from a received transmission SMS message, forms a message footer including the encoded phone number of the initial sender and the encoded phone numbers of the respective one or more recipients, combines the message footer with a message text included in the transmission SMS message, and transmits the transmission SMS message with the message footer to a message server; and
a storage unit that stores the transmission SMS message.

12. The apparatus of claim 11, wherein the controller receives the transmission SMS message with the message footer from the message server, and extracts the phone numbers of the respective one or more recipients by decoding the message footer.

13. The apparatus of claim 12, wherein the controller detects a selection of reply to all, and transmits an SMS message to all of the extracted phone numbers of the respective one or more recipients when the selection is detected.

14. The apparatus of claim 12 where the SMS message is additionally transmitted to the initial sender.

15. The apparatus of claim 11 further comprising an encoder/decoder, and wherein when encoding said each of the phone number of a caller and the phone numbers of the respective one or more recipients from the transmission SMS message, the controller changes each of national codes and network codes included in the phone number of the initial sender and the phone numbers of the respective one or more recipients according to a mapped predefined dictionary.

16. The apparatus of claim 15, wherein, when encoding said each of the phone number of the caller and the phone numbers of the one or more recipients from the transmission SMS message, the controller decreases a length of the national codes and the network codes of the respective one or more recipients by the national code and the network code of the caller, and decreases a length of customer IDs included in the phone numbers of the respective one or more recipients by a customer ID included in the phone number of the initial sender.

17. The apparatus of claim 16, wherein the encoder/decoder comprises a Huffman encoder/decoder, and when encoding said each of the phone number of the initial sender and the phone numbers of the respective one or more recipients from the transmission SMS message, the controller controls the Huffman encoder/decoder to encode the national codes, the network codes, and the customer IDs included in the phone number of the initial sender and the phone numbers of the respective one or more recipients.

18. The apparatus of claim 11, wherein, when forming the message footer that includes the encoded phone number of the initial sender and the encoded phone numbers of the respective one or more recipients, the controller combines the encoded phone number of the initial sender and the encoded phone numbers of the respective one or more recipients, and encodes the combined encoded phone number of an initial caller and encoded phone numbers of the respective one or more recipients with BASE64.
